(19) United States
(12) Patent Application Publication
(10) Pub. No.: US 2021/0176092 A1
(43) Pub. Date: Jun. 10, 2021

(54) VEHICLES WITH DISPARATE COMMUNICATION ARCHITECTURES AND MULTIPLE GATEWAY MODULES FOR SELECTIVE COMMUNICATION THEREBETWEEN

(71) Applicant: Ford Global Technologies, LLC, Dearborn, MI (US)

(72) Inventors: Florian Frischmuth, Plymouth, MI (US); D. David Cantrell, JR., Saline, MI (US); Zeljko Deljevic, Plymouth, MI (US); Brij Datta, Detroit, MI (US); Lawrence Queener, Pinckney, MI (US); John Budaj, Royal Oak, MI (US)

(21) Appl. No.: 17/114,783

(22) Filed: Dec. 8, 2020

Related U.S. Application Data
(60) Provisional application No. 62/946,287, filed on Dec. 10, 2019.

(51) Int. Cl. H04L 12/66; H04L 12/40; H04L 29/06

(52) U.S. Cl. CPC H04L 12/66; H04L 12/40013; H04L 2012/40273; H04L 69/08; H04L 12/40032

(57) ABSTRACT

A vehicle communication system includes a first vehicle gateway controller that selects a first subset of signals generated using a first protocol by a first plurality of vehicle controllers. The first vehicle gateway controller also translates the first subset of signals from the first protocol to a second protocol indecipherable by the first plurality of vehicle controllers, and sends the translated first subset of signals to a second vehicle gateway controller.

### CROSS-REFERENCE TO RELATED APPLICATION

This application claims the benefit of Provisional App. No. 62/946,287, filed Dec. 10, 2019, which is hereby incorporated by reference in its entirety.

### TECHNICAL FIELD

This disclosure relates to the communication between vehicle components and controllers.

### BACKGROUND

A Controller Area Network (CAN bus) is a vehicle bus standard that allows microcontrollers and like devices to communicate with their applications running thereon without a host computer. It is a message based protocol in which packets are received by all microcontrollers, including the transmitting microcontroller. For each microcontroller, packetized data is transmitted sequentially. If more than one device transmits at a same time, however, the highest priority device is able to continue while the others wait.

Ethernet is a computer networking technology commonly used in local area networks, such as a those in vehicles. Systems communicating over Ethernet divide a stream of data into frames. Each frame contains source and destination addresses, and error-checking data. The error-checking data can be used to detect and discard suspect frames. Ethernet may provide services up to and including the data link layer.

### SUMMARY

A vehicle includes first and second pluralities of control modules. The first plurality of control modules is configured to communicate via a first protocol. The second plurality of control modules is configured to communicate via a second protocol different than the first protocol. The first protocol is indecipherable by the second plurality of control modules. The second protocol is indecipherable by the first plurality of control modules. The vehicle also includes first and second gateway modules. The first gateway module is configured to select a first subset of signals generated by the first plurality of control modules for delivery to the second gateway module. The second gateway module is configured to select a second subset of signals generated by the second plurality of control modules for delivery to the first gateway module. The first gateway module is configured to translate the first subset of signals from the first protocol to the second protocol.

### BRIEF DESCRIPTION OF THE DRAWINGS

FIG. 1 is a block diagram of a vehicle with two different communication architectures and two gateway modules therebetween.

FIG. 2 is a block diagram of a portion of the vehicle of FIG. 1 with control modules communicating via direct physical connection.

FIG. 3 is a block diagram of a portion of the vehicle of FIG. 1 with control modules communicating via Ethernet and the two gateway modules.

FIG. 4 is a block diagram of a portion of the vehicle of FIG. 1 with control modules communicating via CAN and the two gateway modules.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

With reference to FIG. 1, an automotive vehicle 10 includes a first plurality of automotive subsystems 12, a first plurality of control modules (controllers) 14, and a first gateway module (controller) 16. The automotive vehicle 10 also includes a second plurality of automotive subsystems 18, a second plurality of control modules (controllers) 20, and a second gateway module (controller) 22. The first plurality of automotive subsystems 12 includes automotive subsystems 24, 26, 28, 30, 32, 34, etc. The first plurality of control modules 14 includes control modules 36, 38, 40, 42, 44, 46, etc. Likewise, the second plurality of automotive subsystems 18 includes automotive subsystems 48, 50, 52, 54, 56, 58, etc. The second plurality of control modules 20 includes control modules 60, 62, 64, 66, 68, 70, etc. Additional pluralities of automotive subsystems, control modules, and an associated gateway module are also possible.

Control modules may include an air conditioning control module, an anti-lock braking control module, a battery charge control module, a battery engine control module, a body control module, a DC-DC converter control module, a digital signal processing control module, door control modules, a driver assistance system control module, a driver seat control module, a driver state control module, a front trunk control module, a gear shift control module, a headlamp control module, an instrument panel cluster control module, an occupant classification control module, a pedestrian alert control module, a power distribution box control module, a power steering control module, a radio transceiver control module, a remote function actuator control module, a restraints control module, a steering column control module, a telematics control module, a trailer control module, and a wireless control module, etc.

Automotive subsystems may include an air conditioning system, an anti-lock braking system, a DC-DC power converter, doors, a door lock system, an electric machine, a front trunk, headlamps, an instrument panel. cluster, power electronics, a radio transceiver, a steering column, a traction battery, a transmission, seats, various sensors (e.g., occupant sensors, radar sensors, speed sensors, temperature sensors, ultrasonic sensors, etc.), and wireless charging equipment, etc.

Each of the first plurality of control modules may be any one of the control modules mentioned or contemplated. The control module 36 may be an anti-lock braking control module for example. The control module 38 may be a driver state module, etc. A particular control module, however, would not typically be duplicated within the same plurality of control modules or different plurality of control modules. If for example the control module 40 is a telematics control module, none of the other control modules of the plurality 14 would be a telematics control module. However, in certain circumstances, a control module may be duplicated in both of the pluralities 14, 20.

The content of the automotive subsystems of the first plurality 12 is driven by the content of the first plurality of control modules 14. If for example the control module 36 is an anti-lock braking control module, the automotive subsystem 24 may be an anti-lock braking system that executes commands from the control module 36. If for example the control module 38 is a driver state module, the automotive subsystem 26 may be a sensor system that collects and furnishes data to the control module 38. The same holds true for the content of the automotive subsystems of the second plurality 18. Automotive subsystems of the first plurality 12 are therefore under the control of the first plurality of control modules 14. And automotive subsystems of the second plurality 18 are therefore under the control of the second plurality of control modules 20. The plurality of control modules 14 may require inputs from the plurality of control modules 20 through gateway modules 16, 22 and/or the direct line, and vice versa for the plurality of control modules 20.

The first and second plurality of control modules 14, 20 each has a unique architecture with its own protocols and communication standards. That is, communication between control modules of the first plurality 14 may adhere to one standard or protocol, while communication between control modules of the second plurality 20 may adhere to another standard or protocol indecipherable by the first plurality of control modules 14 in its native form even though the first and second plurality of control modules 14, 20 may each implement CAN and Ethernet communications. The gateway modules 16, 22 thus act as go-betweens to facilitate communication between the first and second plurality of control modules 14, 20. This configuration allows different groups to develop plug-and-play sets of componentry for vehicles without having to share all inter-component communication with other plug-and-play sets of componentry.

A gateway module (or gateway electronic control unit) is typically used to control inter-bus communication to facilitate seamless communication between networks in a vehicle. They may implement several interfaces with various communication buses such as CAN and others. They can also facilitate over-the-air updates via wireless fidelity (WiFi) and long term evolution (LTE), etc. Conventionally, a single gateway module (or central hub) may only be necessary within the context of a vehicle as all control modules typically adhere to the same standards or protocols even though there may be several networks therein. Here, however, vehicles are contemplated in which different sets of control modules are “isolated” from one another by virtue of use of their own “language” to communicate. To permit communication between these two camps without the use of a single component that has unfettered access to all communications taking place on each side, multiple gateway modules—one for each side—can be used.

The gateway module 16 performs the conventional hub functions for the first plurality of control modules 14, and the gateway module 22 performs the conventional hub functions for the second plurality of control modules 20. The gateway modules 16, 22, however, also implement additional functionality that permits selective communication. between the first and second plurality of control modules 14, 20. The first gateway module 16 may, for example, filter out certain types of messages and/or signals that are of interest to the second plurality of control modules 20, translate using existing or developed techniques the messages and/or signals from their native formats (e.g., protocol, standard, etc.) into the native formats of the second plurality of control modules 20, and transfer them to the gateway module 22 for delivery to the second plurality of gateway modules 20. The second gateway module 22 can similarly filter out certain types of messages and/or signals that are of interest to the first plurality of control modules 14, translate the messages and/or signals from their native formats into the native formats of the first plurality of control modules 14, and transfer them to the first gateway module 16 for delivery to the first plurality of control modules 14.

In other examples, only the gateway module 16 or only the gateway module 22 may be configured for translation. The gateway module 16 may filter out signals of interest to the second plurality of control modules 20 and transfer them as-is to the gateway module 22, leaving the translation to be performed by the gateway module 22. The gateway module 22, however, may first translate any signals for the first plurality of control modules 14 before transferring them to the gateway module 16 as the gateway module 16 may lack translation capabilities. Other permutations are also possible.

CAN and/or Ethernet, for example, may be used for communication between the first plurality of control modules 14 and the gateway module 16, for communication between the second plurality of control modules 20 and the gateway module 22, and for communication between the gateway modules 16, 22. The time critical nature of the communication may dictate whether, for example, CAN or Ethernet is used. As Ethernet is generally recognized as being faster than CAN, control modules of one of the pluralities 14, 20 needing data within a certain time limit of it being captured or generated by control modules of the other of the pluralities will use Ethernet. Control modules of one of the pluralities 14, 20 not needing data within such a time limit may use CAN.

Latency in communication between the first and second pluralities of control modules 14, 20 via the gateway modules 16, 22 may be unacceptable in some circumstances. Direct physical (or hard-wired) lines may thus span between specific ones of the pluralities 14, 20.

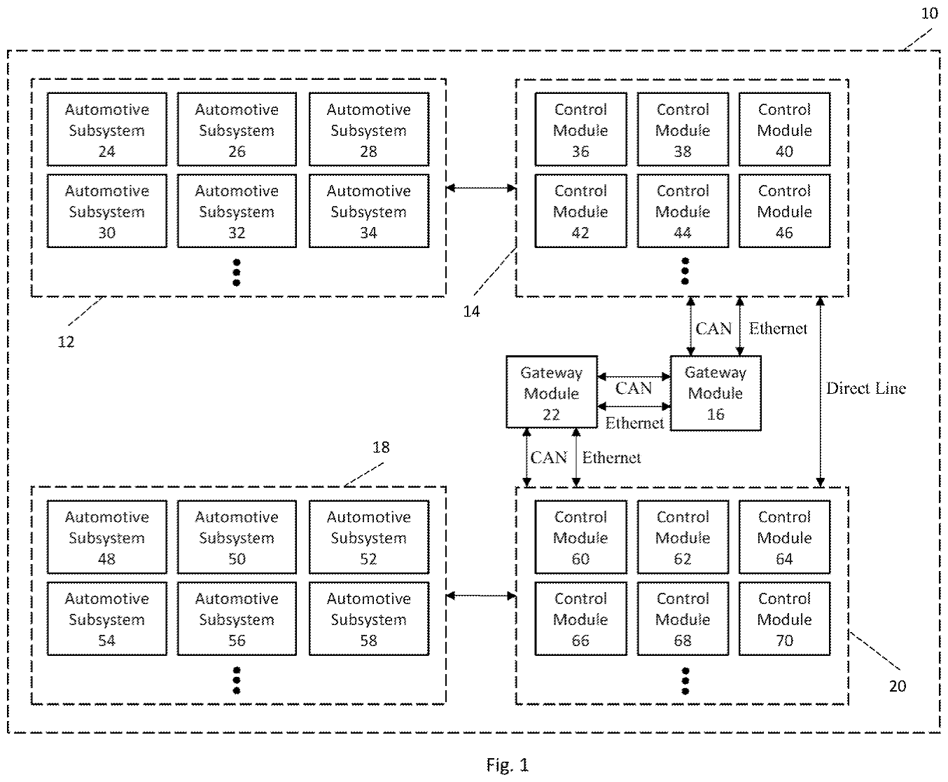

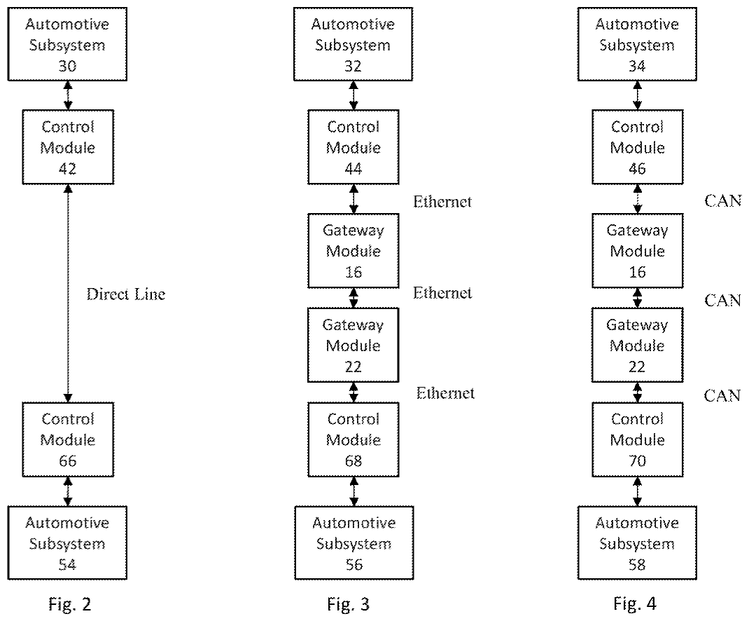

Referring to FIG. 2, the control module 42 may need to receive data about the automotive subsystem 54 every 3 milliseconds for example for proper control of the automotive subsystem 30. As such, the control module 42 and the control module 66, which monitors and controls the automotive subsystem 54, are wired together with a direct physical communication line. As data is received by the control module 66 from the automotive subsystem 54, it can be immediately transferred via the direct physical communication line to the control module 42, bypassing the gateway modules 16, 22.

Referring to FIG. 3, the control module 44 needs to receive data about the automotive subsystem 56 every 9 milliseconds for example for proper control of the automotive subsystem 32. As such, the control module 44 and the control module 68, which monitors and controls the automotive subsystem 56 communicate via Ethernet facilitated by the gateway modules 16, 22. In this example, signals regarding operation of the automotive subsystem 56 passed to the gateway module 22 by the control module 68 are transferred as-is to the gateway module 16. The gateway module 16 then performs the necessary translation before passing the results to the control module 44.

Referring to FIG. 4, the control module 46 needs to receive data about the automotive subsystem 58 every 30 milliseconds for example for proper control of the automotive subsystem 34. As such, the control module 46 and the control module 70, which monitors and controls the automotive subsystem 58 communicate via CAN facilitated by the gateway modules 16, 22. In this example, signals regarding operation of the automotive subsystem 58 passed to the gateway module 22, which then translates them into a format recognized by the first plurality of control modules 14 before passing them to the gateway module 16 for delivery to the control module 46.

Referring again to FIG. 1, a mix of Ethernet and CAN may also be used to facilitate communication between the first and second plurality of control modules 14, 20. Ethernet may be used for communication of certain signals to the gateway module 22. CAN may be used to transmit these signals to the gateway module 16. Then, Ethernet may be used for communication of these signals to the first plurality of control modules 20. Other permutations are also contemplated.

The processes, methods, algorithms, or control modules disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle communication system comprising:
a first vehicle gateway controller configured to select a first subset of signals generated using a first protocol by a first plurality of vehicle controllers, to translate the first subset of signals from the first protocol to a second protocol indecipherable by the first plurality of vehicle controllers, and to send the translated first subset of signals to a second vehicle gateway controller.

2. The vehicle communication system of claim 1 further comprising the second vehicle gateway controller, wherein the second vehicle gateway controller i.s configured to select a second subset of signals generated using the second protocol by a second plurality of vehicle controllers.

3. The vehicle communication system of claim 2, wherein the second vehicle gateway controller is configured to translate the second subset of signals from the second protocol to the first protocol.

4. The vehicle communication system of claim 3, wherein the second vehicle gateway controller is configured to send the translated second subset of signals to the first gateway controller.

5. The vehicle communication system of claim 2, wherein the first vehicle gateway controller is configured to translate the second subset of signals from the second protocol to the first protocol.

6. The vehicle communication system of claim 2, wherein the second vehicle gateway controller is configured to translate the first subset of signals from the first protocol to the second protocol.

7. A vehicle comprising:
first and second pluralities of vehicle controllers, the first plurality of vehicle controllers being configured to communicate via a first protocol, the second plurality of vehicle controllers being configured to communicate via a second protocol different than the first protocol, the first protocol being indecipherable by the second plurality of vehicle controllers, and the second protocol being indecipherable by the first plurality of vehicle controllers; and
first and second vehicle gateway controllers, the first vehicle gateway controller being configured to select a first subset of signals generated by the first plurality of vehicle controllers for delivery to the second vehicle gateway controller, the second vehicle gateway controller being configured to select a second subset of signals generated by the second plurality of vehicle controllers for delivery to the first vehicle gateway controller, and the first vehicle gateway controller being configured to translate the first subset of signals from the first protocol to the second protocol.

8. The vehicle of claim 7, wherein the first vehicle gateway controller is configured to translate the second subset of signals from the second protocol to the first protocol.

9. The vehicle of claim 7, wherein the second vehicle gateway controller is configured to translate the second subset of signals from the second protocol to the first protocol.

10. The vehicle of claim 7, wherein the second vehicle gateway controller is configured to translate the first subset of signals from the first protocol to the second protocol.

11. A communication method for a vehicle, comprising:
translating by a first vehicle gateway controller a selected first subset of signals generated by a first plurality of vehicle controllers from a first protocol to a second protocol indecipherable by the first plurality of vehicle controllers;
sending by the first vehicle gateway controller the translated first subset of signals to a second vehicle gateway controller;
receiving by the second Vehicle gateway controller the translated first subset of signals; and
sending by the second vehicle gateway controller the translated first subset of signals to a second plurality of vehicle controllers.

12. The communication method of claim 11 further comprising translating by the second vehicle gateway controller a selected second subset of signals generated by the second plurality of controllers from the second protocol to the first protocol.

13. The communication method of claim 12 further comprising sending by the second vehicle gateway controller the translated second subset of signals to the first vehicle gateway controller, receiving by the first vehicle gateway controller the translated second subset of signals, and sending by the first vehicle gateway controller the translated second subset of signals to the first plurality of vehicle controllers.

14. The communication method of claim 11 further comprising translating by the first vehicle gateway controller signals in the second protocol to the first protocol.

15. The communication method of claim 11 further comprising translating by the second vehicle gateway controller signals in the first protocol to the second protocol.
